(19) United States
(12) Patent Application Publication
(10) Pub. No.: US 2009/0197070 A1
(43) Pub. Date: Aug. 6, 2009

(54) Support plate

(75) Inventor: Atsushi Miyanari, Kawasaki-Shi (JP)

Correspondence Address: EDWARDS ANGELL PALMER & DODGE LLP, P.O. BOX 55874, BOSTON, MA, 02205, US

(73) Assignee: Tokyo Ohka Kogyo Co., Ltd., Kawasaki-Shi (JP)

(21) Appl. No.: 12/322,093

(22) Filed: Jan. 29, 2009

(30) Foreign Application Priority Data
Feb. 4, 2008 (JP) 024033/2008

(51) Int. Cl. B32B 5/18

(52) U.S. Cl. 428/314.2; 428/316.6

(57) ABSTRACT

The present invention provides a support plate (1) that bonds to a substrate (2) so as to support the substrate (2). In the support plate (1), a plurality of openings (15) and (15′) penetrate through from a bonding surface to a non-bonding surface, the bonding surface facing the substrate (2), and the non-bonding surface facing the bonding surface; a porous region (13), which includes a first region (11) and a second region (12) surrounding the first region, is formed on the bonding surface; and the first region (11) has an opening ratio greater than that of the second region (12). By this, it is possible to realize a support plate that can be easily peeled off from a semiconductor wafer with a solvent, but does not easily come off from a substrate during a processing operation on the semiconductor wafer.

This Nonprovisional application claims priority under U.S.C. § 119(a) on Patent Application No. 024033/2008 filed in Japan on Feb. 4, 2008, the entire contents of which are hereby incorporated by reference.

### FIELD OF THE INVENTION

The present invention relates to a support plate for supporting a substrate such as a semiconductor wafer during a processing operation on the substrate. Specifically, the present invention relates to a support plate to be bonded to the substrate so as to support the substrate during a thickness reduction process of the substrate.

### BACKGROUND OF THE INVENTION

Functional improvement in a cell-phone, a digital AV equipment, an IC card, and the like arises a demand for size reduction, thickness reduction and higher integration of a semiconductor silicon chip (hereinafter referred to as “chip”) to be mounted in such devices. There also is a demand for reduction in thickness of an integrated circuit, such as a CSP (chip size package) and an MCP (multi-chip package), in which a plurality of chips are packaged. Among these integrated circuits, a system-in package (SiP), in which a plurality of chips are mounted in one semiconductor package, is extremely important in achieving size reduction, thickness reduction and higher integration of the chip so that an electronic device to which the chip is mounted can achieve a higher performance, smaller size and lighter weight.

In order to realize an electronic device that achieves a higher performance and is smaller in size and lighter in weight, the chip should be 150 μm or less in thickness. Further, it is necessary for CSP and MCP that the thickness of the chip be reduced to a thickness of 100 μm or less by grinding the chip. The chip for the IC card should be ground to a thickness of 50 μm or less. However, the grinding not only reduces the thickness of a semiconductor wafer serving as a base of the chip, but also decreases strength of the semiconductor wafer. This makes it easier for a crack and warpage to occur in the semiconductor wafer. The semiconductor wafer reduced in thickness cannot be automatically transported, but has to be manually transported. This requires complicated handling of the semiconductor wafer.

There has been a technique, which makes it difficult to break a substrate such as a semiconductor wafer during a thickness reduction process of the substrate. Japanese Unexamined Patent Publication, Tokukai, 2005-191550 (publication date: Jul. 14, 2005), for example, discloses such a technique. Japanese Unexamined Patent Publication, Tokukai, 2005-191550 discloses a wafer supporting system for maintaining strength of the semiconductor wafer by bonding glass or a rigid plastic called a support plate to the semiconductor wafer to be ground. This prevents a crack and a warpage in the semiconductor wafer. With the wafer supporting system, which makes it possible to maintain the strength of the semiconductor wafer, it becomes possible to automatically transport the semiconductor wafer reduced in thickness. However, it is necessary to spend a certain amount of time to peel off the support plate from the semiconductor wafer because a solvent cannot easily enter between the support plate and the semiconductor wafer.

Japanese Unexamined Patent Publication, Tokukai, 2006-135272 (publication date: May 25, 2006) discloses a support plate having a number of through-holes through which a solvent passes in a thickness direction of the support plate, and a peeling method using the support plate. The technique of Japanese Unexamined Patent Publication, Tokukai, 2006-135272 requires a short period of time to supply the solvent to a bonding layer for bonding the support plate to a substrate. This makes it possible to reduce time taken for peeling off the support plate from the semiconductor wafer.

### SUMMARY OF THE INVENTION

The inventors of the present invention have found that the use of a conventional support plate is associated with such a problem that a circumference of the support plate tends to easily come off from a substrate because the substrate and the support plate curve due to heat during an etching process or a CVD process that is carried out after the support plate is bonded to the substrate.

The present invention has been accomplished in view of the problem above, and an object of the present invention is to provide a support plate that can be easily peeled off from a semiconductor wafer with a solvent, but does not easily come off from a substrate during a processing of the semiconductor wafer.

As a result of diligent studies on the object, which is newly and uniquely found by the inventors, the inventors of the present invention improved an adhesion between a substrate and a support plate having through-holes, without impairing easiness in peeling the support plate off from the substrate. By this, the inventors of the present invention accomplished the present invention. The object was newly found by the inventors of the present invention as a result of studies on the support plate and has not been known in this field.

A support plate in accordance with the present invention is a support plate bonding to a substrate so as to support the substrate, having: a plurality of openings penetrating through from a bonding surface to a non-bonding surface, the bonding surface facing the substrate, and the non-bonding surface facing the bonding surface, the bonding surface including a first region and a second region that surrounds the first region, and the first region having an opening ratio greater than that of the second region.

It is preferable that the support plate in accordance with the present invention is arranged so that the second region has an area that is 0.5 to 50% of the bonding surface. That is, it is preferable that the first region has an area that is 50% to 99.5% of the bonding surface. The support plate in accordance with the present invention may be arranged so that a region not having the opening is formed at an outer edge of the bonding surface. In this case, the areas of the first region and the second region are adjusted so as to constitute 100% of the bonding surface area along with the region not having the opening. It is preferable that the region not having the opening has an area not more than 10% of the bonding surface area.

In the support plate in accordance with the present invention, it is preferable that the bonding surface has an opening ratio of 10% to 40%. It is preferable that the support plate in accordance with the present invention is arranged so that the openings in the first region are 0.1 mm to 11.0 mm in diameter; and the openings in the first region are larger in diameter than the openings in the second region. It is preferable that the support plate in accordance with the present invention is arranged so that the openings in the first region are formed at intervals of 0.1 mm to 1.5 mm; and the intervals between the openings in the first region are smaller than intervals between the openings in the second region.

In the support plate in accordance with the present invention, the openings are not particularly limited in cross-sectional shape and may cross-sectionally have a cylindrical shape, an hourglass shape, a taper shape, or the like. In cases of the cylindrical shape and the hourglass shape, the openings have a same shape on both of the surfaces of the support plate, unlike a case of the taper shape. This prevents the plate from curving due to a difference in diameter in a vertical direction of the openings. Further, either surface can serve as the bonding surface (and non-bonding surface) without face selectivity. Therefore, it is preferable that the cross-sectional shape of the openings is the cylindrical shape or the hourglass shape.

In particular, the hourglass shape achieves a high peeling efficiency because a peeling solution is in contact with the bonding surface in a large area when peeling off the support plate from the substrate. Further, the hourglass shape makes it possible to suppress a reduction in strength of the support plate caused by a formation of the openings, because the openings have a diameter becoming thinner toward the center in a thickness direction of the support plate.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a schematic view showing an arrangement of a support plate in accordance with the present invention.

FIG. 2 is a view showing a shape of openings formed on a support plate in accordance with the present invention.

### REFERENCE SIGNS LIST

1: SUPPORT PLATE
2: SEMICONDUCTOR WAFER (SUBSTRATE)
3: BONDING LAYER
11: FIRST REGION
12: SECOND REGION
13: POROUS REGION
14: OUTER EDGE REGION
15: THROUGH-HOLE (OPENING)

### DESCRIPTION OF THE EMBODIMENTS

As described above, the inventors of the present invention have found that, when processing a semiconductor wafer in the presence of a support plate that has a number of through-holes, the support plate easily comes off from a substrate during a CVD process and an etching process. As a result of diligent studies, the inventors of the present invention have achieved an arrangement in which a solvent (peeling solution) effectively works in peeling off a support plate having through-holes from a substrate; and the support plate is improved in adhesion to the substrate, which adhesion is required for handling during processing operations.

A support plate in accordance with the present invention is not limited to particular usage, provided that it is used in supporting a substrate. The support plate is not particularly limited in shape. It is preferable that the support plate is flat on a surface at which the support plate is bonded to the substrate, and that the support plate has a shape similar to the substrate (that is, a similar figure of the substrate). It is more preferable that the surface to be bonded to the substrate has a circular shape.

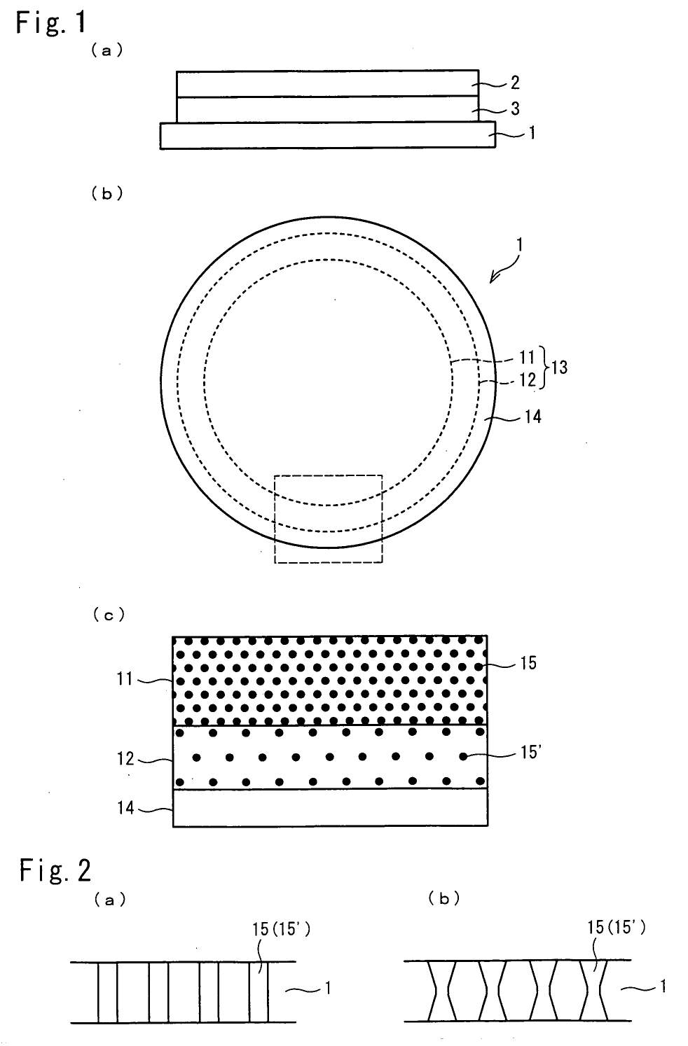

One embodiment of a support plate in accordance with the present invention is described below with reference to (a) through (c) of FIG. 1. The support plate shown in FIG. 1 is for supporting a circular semiconductor wafer, for example. However, the present invention is not limited to this.

In FIG. 1, (a) is a view showing a vertical cross-section of a semiconductor wafer 2, bonded with a support plate 1 in accordance with the present embodiment via a bonding layer 3. The semiconductor wafer 2 is a substrate to be reduced in thickness. Note that a plurality of openings, which is one of the features of the support plate in accordance with the present invention, is omitted in (a) of FIG. 1 for the purpose of easy explanation. With the arrangement in (a) of FIG. 1, in which the support plate 1 in accordance with the present embodiment is used, it is possible to maintain strength of the semiconductor wafer 2 that is reduced in thickness.

As shown in (a) of FIG. 1, the support plate 1 is bonded to the semiconductor wafer 2 so as to support the semiconductor wafer 2. In the present description, a support plate surface bonded to the substrate is referred to as “bonding surface”; and a support plate surface not bonded to the substrate is referred to as “non-bonding surface”.

The support plate can be made from any material, which is strong enough to maintain the strength of the semiconductor wafer to be bonded. The semiconductor wafer is subjected to various processing operations including a wet polishing treatment, an etching treatment, a heat treatment, a CVD treatment, a PVD treatment, a plating treatment, and the like. In order to prevent the support plate bonded to the substrate from curving during the various operations, it is preferable that a heat expansion coefficient of the support plate is similar to that of the substrate. The support plate is preferably made from glass, a rigid plastic, a metal, a ceramic, or silicon. Among these, glass is more preferable. The plate made from such materials is not particularly limited as to how the plate is produced.

The bonding layer 3 is formed between the support plate 1 and the substrate 2. An adhesive agent used in the present invention is preferably a water-insoluble polymer because water is used in grinding the substrate bonded to the support plate. Further, the adhesive agent is more preferably a substance having a high softening point because a high-temperature treatment is applied in the processing operations of the substrate. In view of these, the adhesive agent used in the present invention is preferably a novolac resin, an epoxy resin, an amide resin, a silicone resin, an acrylic resin, a urethane resin, polystyrene, polyvinyl ether, polyvinyl acetate, or a mixture of these. The bonding layer 3 preferably has a thickness of approximately several micrometers to 100 μm. However, the present invention is not limited to this.

A solvent used in peeling off the substrate from the support plate may be an alcohol, ether, ester, alkali solution, ketone, or mixed solution of these. However, the solvent is not limited to these. The solvent may be dropped on a non-bonding surface of the support plate or may be supplied to the non-bonding surface with a spray, an ultrasonic nozzle, or a two-fluid nozzle. When supplying the solvent in the above-mentioned manner, it is preferable to spin the support plate bonded to the substrate, by using a spinner or the like. This allows the solvent to be distributed to the whole bonding layer in a short period of time. Alternatively, the support plate bonded to the substrate may be immersed in the solvent. In this case, applying vibration by ultrasonication or the like allows the solvent to be distributed to the whole bonding layer in a short period of time.

The support plate preferably has a size that is substantially same as a size of the semiconductor wafer or larger than an outer shape of the semiconductor wafer, so as to successfully support the semiconductor wafer. Specifically, when the support plate has a circular shape, it is preferable that the support plate is larger than the semiconductor wafer by approximately 1 to 10 mm in diameter. When the support plate 1 is larger in diameter than the semiconductor wafer 2, it becomes easier to bond the support plate 1 and the semiconductor wafer 2.

In FIG. 1, (a) illustrates an arrangement of the present embodiment, in which a support plate 1 has a size larger than an outer shape of a semiconductor wafer 2. In FIG. 1, (b) is a top view of a bonding surface of a support plate in accordance with the present invention. In FIG. 1, (c) illustrates a part of (b) of FIG. 1. Note that a plurality of openings, which is one of the features of the support plate in accordance with the present invention, is omitted in (b) of FIG. 1 for the purpose of simplifying an explanation.

Since the support plate 1 in accordance with the present embodiment has the size larger than the outer shape of the semiconductor wafer 2, a non-bonding region exists around and outside a bonding region where the support plate 1 and the semiconductor wafer 2 are bonded. The bonding region can be a part where an adhesive agent is applied.

As shown in (c) of FIG. 1, a plurality of openings 15 (15′) are formed on a porous region 13. The openings 15 (15′) penetrate through from a bonding surface to a non-bonding surface. The porous region 13 includes two regions that have different opening ratios, respectively. A first region 11 having a greater opening ratio is surrounded by a second region 12 having a smaller opening ratio.

Since the openings 15 (15′) are formed on the porous region 13, a peeling solution (solvent) used in peeling off the support plate 1 from the semiconductor wafer 2 can directly reach a bonding layer 3 via the openings 15 (15′) even when the solvent is supplied to an outside of the support plate 1. This makes it possible to easily peel off the semiconductor wafer 2 from the support plate 1.

The opening is not necessarily formed on an outer edge region 14. In the support plate in accordance with the present invention, it is preferable that the outer edge region, where the opening is not formed, has an area not more than 10% of a bonding surface area.

The openings on the support plate 1 are preferably formed at an opening ratio in a range from 10% to 40% of the bonding surface. The opening ratio within such a range does not affect automation of transportation of the semiconductor wafer. It is preferable that the opening is not formed in a portion (may be either in the first region or the second region) which is in contact with transporting means.

As shown in (b) and (c) of FIG. 1, the two regions (first region 11 and second region 12) having different opening ratios, respectively, are formed on the porous region 13. The opening ratios of the first region 11 and the second region 12 are determined according to diameters of the openings 15 and the openings 15′, respectively, and/or according to intervals between the openings 15 and the openings 15′, respectively. It is not necessary that all of the openings formed in the first region (or the second region) have a same diameter. Likewise, it is not necessary that all of the openings are formed at same intervals in the first region (or the second region). Note that, for the purpose of simplifying an explanation of the first region 11, the second region 12, and the outer edge region 14, borders between these regions are indicated by dashed lines in (b) and (c) of FIG. 1.

In a support plate in accordance with the present invention, the openings formed in the first region preferably are in a range from 0.1 mm to 1.0 mm in diameter, more preferably in a range from 0.1 mm to 0.5 mm in diameter, further preferably in a range from 0.2 mm to 0.4 mm in diameter. It is preferable that the openings in the first region are larger in diameter than those in the second region.

In a support plate in accordance with the present invention, the openings in the first region are preferably formed at intervals in a range from 0.1 mm to 1.5 mm, more preferably in a range from 0.2 mm to 1.0 mm. It is preferable that the openings in the first region are formed at smaller intervals than those in the second region.

A method for forming the openings is known in this field and is selected as appropriate according to a material of the support plate. The openings may be formed by opening from both surfaces of the support plate or one surface of the support plate. In order to prevent the support plate from curving or bending, it is preferable that the openings have an hourglass shape (a shape constricted in the middle, that is, a so-called gourd shape). Alternatively, the openings may have a cylindrical shape ((a) and (c) of FIG. 2).

As described above, the present invention makes it possible to improve adhesion between a substrate and a support plate, which adhesion is required for handling during processing operations on the substrate. Further, with the present invention, it is possible to reduce time required for peeling off the substrate 2 from the support plate 1 with a solvent, and to prevent the substrate 2 from breaking when being peeled off. In order to successfully peel off the support plate in accordance with the present invention from the substrate, it is preferable that the second region has an area which is 0.5% to 50% of the bonding surface. That is to say, it is preferable that the first region has an area which is 50% to 99.5% of the bonding surface. Even when an opening ratio of the bonding surface stays within a range from 10% to 40% as described above, it is preferable that the second region has a smaller opening ratio than the first region. By arranging so that the second region has the smaller opening ratio than the first region, it is possible to attain the effect of the present invention.

In a support plate in accordance with the present invention, which has a plurality of through-holes, a solvent (peeling solution) supplied from an outside of the support plate can directly reach a bonding layer via the through-holes. In this way, the present invention makes it possible to achieve an effect of the peeling solution in a short period of time. Further, the present invention makes it possible to prevent a substrate from coming off during a CVD process and an etching process.

A support plate in accordance with the present invention is suitably applicable to a processing operation on a semiconductor wafer or a chip, and greatly contributes to reduction of processing time.

All of the academic documents and the patent documents described in the present description are incorporated by reference herein.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A support plate bonding to a substrate so as to support the substrate, having:
a plurality of openings penetrating through from a bonding surface to a non-bonding surface, the bonding surface facing the substrate, and the non-bonding surface facing the bonding surface,
the bonding surface including a first region and a second region that surrounds the first region, and
the first region having an opening ratio greater than that of the second region.

2. The support plate according to claim 1, wherein:
the openings in the first region are 0.1 mm to 1.0 mm in diameter; and
the openings in the first region are larger in diameter than the openings in the second region.

3. The support plate according to claim 1, wherein:
the openings in the first region are formed at intervals of 0.1 mm to 1.5 mm; and
the intervals between the openings in the first region are smaller than intervals between the openings in the second region.

4. The support plate according to claim 1, wherein the bonding surface has an opening ratio of 10% to 40%.

5. The support plate according to claim 1, wherein a region not having the opening is formed at an outer edge of the bonding surface.

6. The support plate according to claim 1, wherein the first region has an area that is 50% to 99.5% of the bonding surface.

7. The support plate according to claim 1, wherein the openings have an hourglass shape.
